(19) United States
(12) Patent Application Publication
(10) Pub. No.: US 2020/0072419 A1
(43) Pub. Date: Mar. 5, 2020

(54) PRESSURE-DIFFERENCE TRANSMISSION APPARATUS

(71) Applicant: TE-MING CHIANG, HSINCHU CITY (TW)

(72) Inventor: TE-MING CHIANG, HSINCHU CITY (TW)

(21) Appl. No.: 16/253,377

(22) Filed: Jan. 22, 2019

(30) Foreign Application Priority Data
Sep. 3, 2018 (TW) 107130805

(51) Int. Cl. F17D 1/12; F17D 1/20; F17D 3/01; F17D 3/10

(52) U.S. Cl. CPC F17D 1/12; F17D 3/10; F17D 3/01; F17D 1/20

(57) ABSTRACT

A pressure-difference transmission apparatus includes a main conduit sequentially connected to a first pressurizing device, an inlet device, an outlet device and a relief device, wherein the first pressurizing device and a second pressurizing device are in communication with the main conduit to provide pressure thereto; and a communication device connected to the relief device and in communication with an external atmospheric environment, wherein the inlet device has an inlet switch and a relief switch, the inlet switch controlling whether the inlet device and the main conduit are in communication with each other, the relief switch controlling whether the relief device and the main conduit are in communication with each other, and the communication device has a communication switch for controlling whether the communication device and the relief device are in communication with each other, thereby precluding a waste of drug, energy and time during transmission of drug.

### CROSS-REFERENCE TO RELATED APPLICATION

This non-provisional application claims priority under 35 U.S.C. § 119(a) on Patent Application No(s). 107130805 filed in Taiwan, R.O.C. on Sep. 3, 2018, the entire contents of which are hereby incorporated by reference.

### FIELD OF THE INVENTION

The present disclosure relates to transmission apparatuses and, more particularly, to a pressure-difference transmission apparatus.

### BACKGROUND OF THE INVENTION

Plants which manufacture electronic products by mass production usually carry out a manufacturing process, such as an electroplating process and an etching process, using liquid chemicals. Before being fed to a chemical tank of a process machine, the liquid chemicals may be transmitted to a certain location for test or analysis in order to meet needs regarding testing and/or experimental analysis.

Conventional flow-style transmission apparatuses fill a transmission conduit entirely with a transmitted drug, causing a waste of drug and a remaining trace of drug. Moreover, in the event of a long transmission distance (say 100 m or more), it will consume much energy and take much time to transmit the drug to its destination.

In view of this, it is imperative to provide a transmission apparatus which overcomes the aforesaid drawbacks of the prior art.

### SUMMARY OF THE INVENTION

It is an objective of the present disclosure to provide a pressure-difference transmission apparatus which overcomes drawbacks of the prior art, that is, conventional flow-style transmission apparatuses are likely to not only cause a waste of drug and a remaining trace of drug but also consume much energy and take much time in the event of a long transmission distance.

In order to achieve the above and other objectives, the present disclosure provides a pressure-difference transmission apparatus, comprising: a main conduit sequentially connected to a first pressurizing device, an inlet device, an outlet device and a relief device, wherein the first pressurizing device and a second pressurizing device are in communication with the main conduit to provide pressure to the main conduit; and a communication device connected to the relief device and in communication with an external atmospheric environment, wherein the inlet device comprises an inlet switch and a relief switch, the inlet switch controlling whether the inlet device and the main conduit are in communication with each other, the relief switch controlling whether the relief device and the main conduit are in communication with each other, and the communication device comprises a communication switch for controlling whether the communication device and the relief device are in communication with each other.

In an embodiment of the present disclosure, the pressure-difference transmission apparatus comprises a plurality of relief devices connected in parallel or in series.

In an embodiment of the present disclosure, the first pressurizing device and the second pressurizing device provide an inert gas for maintaining pressure inside the main conduit.

In an embodiment of the present disclosure, the inert gas is argon gas or nitrogen gas.

In an embodiment of the present disclosure, the main conduit has a sensing region, and the pressure-difference transmission apparatus further comprises a sensing device disposed in the sensing region.

In an embodiment of the present disclosure, the sensing device is a light sensor or a sound sensor.

In an embodiment of the present disclosure, the pressure-difference transmission apparatus further comprises at least one supply device connected to the main conduit and disposed between the first pressurizing device and the inlet device.

In an embodiment of the present disclosure, the pressure-difference transmission apparatus further comprises a plurality of pressure-sensing devices disposed in the main conduit.

In an embodiment of the present disclosure, the pressure-difference transmission apparatus further comprises a buffer device disposed on an outer surface of the main conduit.

In an embodiment of the present disclosure, the first pressurizing device and a port of the main conduit, the second pressurizing device and the port of the main conduit, the inlet device and the port of the main conduit, the outlet device and the port of the main conduit are made of sapphire.

Therefore, in an embodiment of the present disclosure, the pressure-difference transmission apparatus allows, through the first pressurizing device and the second pressurizing device, the main conduit to enter a fully-pressurized state such that pores on the inner wall of the main conduit are compressed and minimized, thereby preventing the drug from entering the pores and staying in the pores while being transmitted within the main conduit, not to mention that a waste of drug is precluded. Furthermore, it is feasible to transmit the drug to its destination without consuming much energy despite a long drug transmission distance. In doing so, the required drug transmission speed is lower than that of conventional flow-style transmission apparatuses.

### BRIEF DESCRIPTION OF THE DRAWINGS

FIG. 1 is a schematic view of a pressure-difference transmission apparatus according to an embodiment of the present disclosure; and

FIG. 2 is a schematic view of the pressure-difference transmission apparatus according to another embodiment of the present disclosure.

### DETAILED DESCRIPTION OF THE PREFERRED EMBODIMENTS

Objectives, features, and advantages of the present disclosure are hereunder illustrated with specific embodiments, depicted with drawings, and described below. The present disclosure is implemented or applied by other different, specific embodiments. Various modifications and changes can be made in accordance with different viewpoints and applications to details disclosed herein without departing from the spirit of the present disclosure. Furthermore, the accompanying drawings of the present disclosure are illustrative but are not drawn to scale. Technical features of the present disclosure are illustrated by embodiments and described below, but the embodiments are not restrictive of the claims of the present disclosure.

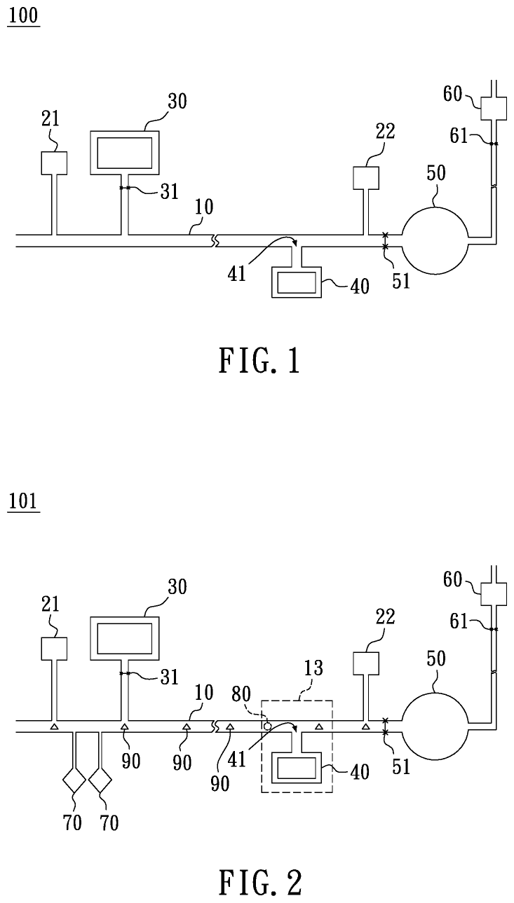

FIG. 1 is a schematic view of a pressure-difference transmission apparatus 100 according to an embodiment of the present disclosure. In this embodiment, the pressure-difference transmission apparatus 100 comprises a main conduit 10 and a communication device 60. The main conduit 10 is sequentially connected to a first pressurizing device 21, an inlet device 30, an outlet device 40, a second pressurizing device 22 and a relief device 50. Both the first pressurizing device 21 and the second pressurizing device 22 are in communication with the main conduit 10 to provide pressure to the main conduit 10, and thus the main conduit 10 is completely fully-pressurized.

Being fully-pressurized, the main conduit 10 has therein internal pressure higher than external atmospheric pressure (i.e., the atmospheric pressure outside the main conduit 10). For instance, the first pressurizing device 21 and the second pressurizing device 22 are in communication with the main conduit 10, and thus the pressure inside the main conduit 10 is always 2 atmospheric pressure. According to the present disclosure, the pressure inside the main conduit 10 fully-pressurized is not necessarily 2 atmospheric pressure. Hence, the first pressurizing device 21 and the second pressurizing device 22 can be adjusted as needed, and thus the interior of the main conduit 10 can have different pressure levels (say 3 atmospheric pressure).

The inlet device 30, the outlet device 40 and the relief device 50 are connected to the main conduit 10. As shown in FIG. 1, the inlet device 30 is disposed between the first pressurizing device 21 and the second pressurizing device 22. The outlet device 40 is disposed between the inlet device 30 and the second pressurizing device 22. The second pressurizing device 22 is disposed between the outlet device 40 and the relief device 50. The communication device 60 is connected to the relief device 50 and is in communication with an external atmospheric environment.

In this embodiment, the inlet device 30 comprises an inlet switch 31. The inlet switch 31 controls whether the inlet device 30 and the main conduit 10 are in communication with each other. The relief device 50 comprises a relief switch 51. The relief switch 51 controls whether the relief device 50 and the main conduit 10 are in communication with each other. The communication device 60 comprises a communication switch 61. The communication switch 61 controls whether the communication device 60 and the relief device 50 are in communication with each other.

Transmission of a drug with the pressure-difference transmission apparatus 100 is hereunder illustrated by an embodiment shown in FIG. 1.

First, the drug to be transmitted is placed in the inlet device 30. At this moment, the main conduit 10 has already been completely pressurized by the first pressurizing device 21 and the second pressurizing device 22, so as to be fully-pressurized to attain around 2 atmospheric pressure. The inlet switch 31 of the inlet device 30, the relief switch 51 of the relief device 50, and the communication switch 61 of the communication device 60 are closed.

In this embodiment, the first pressurizing device 21 and the second pressurizing device 22 provide an inert gas for maintaining the pressure inside the main conduit 10. The inert gas is, for example, argon gas or nitrogen gas. The inert gas is stable and unlikely to react with the drug, thereby maintaining the fully-pressurized state in the main conduit 10.

Afterward, turn on the inlet switch 31 such that the main conduit 10 and the inlet device 30 are in communication with each other. After the pressure inside the inlet device 30 and the main conduit 10 has attained equilibrium, turn on the relief switch 51 such that the main conduit 10 and the relief device 50 are in communication with each other. Before the main conduit 10 and the relief device 50 are in communication with each other, the pressure inside the relief device 50 is, for example, equal to the external atmospheric pressure, that is, lower than the pressure inside the main conduit 10. Hence, after the relief switch 51 has been turned on, the relief device 50 provides a movement space to the gas of the main conduit 10, and thus a portion of the drug leaves the inlet device 30 for the main conduit 10.

In this embodiment, the relief device 50 is 30 mL in volume, but the present disclosure is not limited thereto. The volume of the relief device 50 is adjusted according to the volume of the portion of the drug to be admitted. Although the embodiment illustrated by FIG. 1 shows just one relief device 50, the present disclosure is not limited thereto. In a variant embodiment, the pressure-difference transmission apparatus 100 comprises a plurality of relief devices 50 connected in parallel or in series. The relief devices 50 each comprise a relief switch 51 to meet various needs (for example, the volume of the portion of the drug to be admitted). After the portion of the drug has been admitted to the main conduit 10, turn off the inlet switch 31.

Afterward, turn on the communication switch 61 such that the communication device 60 and the relief device 50 are in communication with the main conduit 10 and are in communication with an external atmospheric environment. At this moment, since the pressure inside the main conduit 10 (around 2 atmospheric pressure) is higher than the pressure (around 1 atmospheric pressure) of the external atmospheric environment, the communication device 60 and the relief device 50 become in communication with the main conduit 10 to therefore drive the portion of the drug already in the main conduit 10 to move toward the outlet device 40 quickly.

Turn off the communication switch 61 as soon as the drug approaches a collection hole 41 of the outlet device 40 such that drug stays in the vicinity of the collection hole 41 steadily. Then, the drug staying in the vicinity of the collection hole 41 is admitted to the outlet device 40 by low temperature, reduction of pressure, or turning on a motor to generate suction. The present disclosure is not restrictive of the way of admitting the drug to the outlet device 40 and thus can be adjusted as needed. For instance, the outlet device 40 is a test machine provided in a plural number.

In an embodiment of the present disclosure, the pressure-difference transmission apparatus 100 allows, through the first pressurizing device 21 and the second pressurizing device 22, the main conduit 10 to enter a fully-pressurized state such that pores on the inner wall of the main conduit 10 are compressed and minimized, thereby preventing the drug from entering the pores and staying in the pores while being transmitted within the main conduit 10. The drug being transmitted within the main conduit 10 in an environment of a pressure higher than the external environment manifests a reduction in vapor pressure and thus is more unlikely to linger within the main conduit 10 because of vaporization.

By altering the pressure inside the main conduit 10 and therefore transmitting the drug, it is not necessary to fill the main conduit 10 entirely with the drug transmitted; instead, it is only necessary to transmit just a sufficient amount (volume) of the drug to avoid a waste of drug.

Pressurizing devices (the first pressurizing device 21 at the front end, and the second pressurizing device 22 at the back end) are provided at both the front end and the back end in the course of transmission to enhance pressurizing capability such that the main conduit 10 is fully-pressurized. Then, by altering the pressure inside the main conduit 10 and thus transmitting the drug, it is feasible to transmit the drug to its destination without consuming much energy despite a long distance (say 100 m or more) of transmission of the drug. In doing so, the required drug transmission speed is lower than that of conventional flow-style transmission apparatuses.

In an embodiment of the present disclosure, depending on its need for fully-pressurized state, the main conduit 10 of the pressure-difference transmission apparatus 100 has a small diameter and a thick wall such that the pressure-difference transmission apparatus 100 has higher mechanical strength than the conventional flow-style transmission apparatuses. In a variant embodiment, the pressure-difference transmission apparatus 100 further comprises a buffer device disposed on the outer surface of the main conduit 10. For instance, the buffer device is made of a buffer resilient material to further protect and reinforce the main conduit 10.

In an embodiment, the first pressurizing device 21 and a port of the main conduit 10, the second pressurizing device 22 and the port of the main conduit 10, the inlet device 30 and the port of the main conduit 10, the outlet device 40 and the port of the main conduit are made of sapphire. Since sapphire is capable of satisfactory electrical insulation, thermal conductivity and mechanical properties and has a Mohs' scale of mineral hardness of 9, the port made of sapphire is resistant to abrasion, thereby extending the service life of the pressure-difference transmission apparatus 100.

FIG. 2 is a schematic view of a pressure-difference transmission apparatus 101 according to another embodiment of the present disclosure. Similarly, the pressure-difference transmission apparatus 101 comprises a main conduit 10, a first pressurizing device 21, a second pressurizing device 22, an inlet device 30, an outlet device 40, a relief device 50 and a communication device 60. The first pressurizing device 21 and the second pressurizing device 22 are in communication with the main conduit 10. The inlet device 30, the outlet device 40 and the relief device 50 are connected to the main conduit 10. The inlet device 30 is disposed between the first pressurizing device 21 and the second pressurizing device 22. The outlet device 40 is disposed between the inlet device 30 and the second pressurizing device 22. The second pressurizing device 22 is disposed between the outlet device 40 and the relief device 50. The communication device 60 is connected to the relief device 50 and is in communication with the external atmospheric environment.

In this embodiment, the pressure-difference transmission apparatus 101 further comprises at least one supply device 70 (FIG. 2 shows two supply devices 70, and the number of the supply devices 70 is subject to changes as needed) but the present disclosure is not limited thereto. The supply devices 70 are connected to the main conduit 10 and disposed between the first pressurizing device 21 and the inlet device 30. The supply devices 70 contain a detergent or a formulated-beforehand/impromptu acidic or alkaline liquid to cleanse the main conduit 10 or provide subsequent analysis and preparation. The locations of the supply devices 70 are not necessarily what are depicted by FIG. 2 but are subject to changes as needed.

As shown in FIG. 2, the main conduit 10 has a sensing region 13, whereas the pressure-difference transmission apparatus 101 further comprises a sensing device 80. The sensing device 80 is disposed in the sensing region 13. For instance, the sensing device 80 is a light sensor or a sound sensor, whereas the sensing region 13 covers the periphery of the collection hole 41 of the outlet device 40. As soon as the drug enters the sensing region 13 (that is, as soon as the drug approaches the collection hole 41 of the outlet device 40), the sensing device 80 senses the drug and thus turns off the communication switch 61 such that the drug can always stay in the vicinity of the collection hole 41.

In an embodiment, the pressure-difference transmission apparatus 101 further comprises a plurality of pressure-sensing devices 90. The pressure-sensing devices 90 are disposed in the main conduit 10. For instance, the pressure-sensing devices 90 are uniformly distributed throughout the main conduit 10. The first pressurizing device 21 and the second pressurizing device 22 render the main conduit 10 fully-pressurized entirely; hence, if the main conduit 10 is damaged or fails, pressure inside the main conduit 10 will change. The pressure change is instantly sensed by the pressure-sensing devices 90, and thus technicians come to its rescue quickly.

Therefore, the pressure-difference transmission apparatus of the present disclosure transmits a drug without causing a waste of drug or leaving a remaining trace of drug, and transmits the drug without consuming much energy or taking much time despite of a long distance (say 100 m or more) of transmission of the drug.

The present disclosure is disclosed above by preferred embodiments. However, persons skilled in the art should understand that the preferred embodiments are illustrative of the present disclosure only, but shall not be interpreted as restrictive of the scope of the present disclosure. Hence, all equivalent modifications and replacements made to the aforesaid embodiments shall fall within the scope of the present disclosure. Accordingly, the legal protection for the present disclosure shall be defined by the appended claims.

What is claimed is:

1. A pressure-difference transmission apparatus, comprising:
a main conduit sequentially connected to a first pressurizing device, an inlet device, an outlet device and a relief device, wherein the first pressurizing device and a second pressurizing device are in communication with the main conduit to provide pressure to the main conduit; and
a communication device connected to the relief device and in communication with an external atmospheric environment,
wherein the inlet device comprises an inlet switch and a relief switch, the inlet switch controlling whether the inlet device and the main conduit are in communication with each other, the relief switch controlling whether the relief device and the main conduit are in communication with each other, and the communication device comprises a communication switch for controlling whether the communication device and the relief device are in communication with each other.

2. The pressure-difference transmission apparatus of claim 1, wherein the pressure-difference transmission apparatus comprises a plurality of relief devices connected in parallel or in series.

3. The pressure-difference transmission apparatus of claim 1, wherein the first pressurizing device and the second pressurizing device provide an inert gas for maintaining pressure inside the main conduit.

4. The pressure-difference transmission apparatus of claim 3, wherein the inert gas is argon gas or nitrogen gas.

5. The pressure-difference transmission apparatus of claim 1, wherein the main conduit has a sensing region, and the pressure-difference transmission apparatus further comprises a sensing device disposed in the sensing region.

6. The pressure-difference transmission apparatus of claim 1, wherein the sensing device is a light sensor or a sound sensor.

7. The pressure-difference transmission apparatus of claim 1, further comprising at least one supply device connected to the main conduit and disposed between the first pressurizing device and the inlet device.

8. The pressure-difference transmission apparatus of claim 1, further comprising a plurality of pressure-sensing devices disposed in the main conduit.

9. The pressure-difference transmission apparatus of claim 1, further comprising a buffer device disposed on an outer surface of the main conduit.

10. The pressure-difference transmission apparatus of claim 1, wherein the first pressurizing device and a port of the main conduit, the second pressurizing device and the port of the main conduit, the inlet device and the port of the main conduit, the outlet device and the port of the main conduit are made of sapphire.
